(19) United States
(12) Patent Application Publication
(10) Pub. No.: US 2007/0222708 A1
(43) Pub. Date: Sep. 27, 2007

(54) Plasma display apparatus

(75) Inventor: Kirack Park, Chilgok-gun (KR)

Correspondence Address: KED & ASSOCIATES, LLP, P.O. Box 221200, Chantilly, VA, 20153-1200, US

(73) Assignee: LG Electronics Inc.

(21) Appl. No.: 11/501,709

(22) Filed: Aug. 10, 2006

(30) Foreign Application Priority Data
Mar. 21, 2006 (KR) 10-2006-0025887

(51) Int. Cl. G09G 3/28

(52) U.S. Cl. 345/60

(57) ABSTRACT

A plasma display apparatus is disclosed. The plasma display apparatus includes a plasma display panel comprising a scan electrode, and a scan driver for supplying a driving signal to the scan electrode in a first subfield and a second subfield. The duration of a first period ranging from a supply start time point of a scan reference voltage to a supply start time point of a scan signal in the first subfield is different from the duration of a second period ranging from a supply start time point of a scan reference voltage to a supply start time point of a scan signal in the second subfield.

This Nonprovisional application claims priority under 35 U.S.C. §119(a) on Patent Application No.10-2006-0025887 filed in Korea on Mar. 21, 2006 the entire contents of which are hereby incorporated by reference.

### BACKGROUND OF THE INVENTION

1. Field of the Invention

This document relates to a plasma display apparatus.

2. Description of the Background Art

A related art plasma display apparatus comprises a plasma display panel comprising a plurality of electrodes and a driver for driving electrodes of the plasma display panel.

The driver supplies a driving voltage to the electrodes of the plasma display panel such that a discharge is generated. In other words, the driving voltage generates a reset discharge, an address discharge and a sustain discharge within discharge cells of the plasma display panel.

When the driving voltage generates the discharge within the discharge cells, a discharge gas filled in the discharge cells generates high frequency light such as vacuum ultraviolet rays.

The high frequency light emits a phosphor layer formed in the discharge cells and the phosphor layer generates visible light such that an image is displayed.

Since the above-described plasma display apparatus can be manufactured to be thin and light, the plasma display apparatus has been considered as a display apparatus.

However, there is a problem in that an erroneous discharge is generated in the related art plasma display apparatus due to various causes such as a change in a temperature of the plasma display panel.

For example, when a temperature of the plasma display panel is a high temperature relatively more than a normal temperature, wall charges are not enough to generate the discharge within the discharge cells. Therefore, the intensity of the reset discharge, the address discharge or the sustain discharge becomes excessively weak, or even the discharge is not generated.

### SUMMARY OF THE INVENTION

Embodiments of the present invention provide a plasma display apparatus capable of reducing the generation of an erroneous discharge by improving a driving signal supplied to a scan electrode.

According to an aspect, there is provided a plasma display apparatus comprising a plasma display panel comprising a scan electrode, and a scan driver for supplying a driving signal to the scan electrode in a first subfield and a second subfield, wherein the duration of a first period ranging from a supply start time point of a scan reference voltage to a supply start time point of a scan signal in the first subfield is different from the duration of a second period ranging from a supply start time point of a scan reference voltage to a supply start time point of a scan signal in the second subfield.

According to another aspect, there is provided a plasma display apparatus comprising a plasma display panel comprising a scan electrode, and a scan driver for supplying a driving signal to the scan electrode in a first subfield and a second subfield, wherein the duration of a first period ranging from a supply start time point of a scan reference voltage to a supply start time point of a scan signal in the first subfield at a first temperature is different from the duration of a second period ranging from a supply start time point of a scan reference voltage to a supply start time point of a scan signal in the second subfield at a second temperature.

According to still another aspect, there is provided a plasma display apparatus comprising a plasma display panel comprising a scan electrode, and a scan driver for supplying a driving signal to the scan electrode in a first subfield and a second subfield, wherein the duration of a first period ranging from a supply start time point of a scan reference voltage to a supply start time point of a scan signal in the first subfield is different from the duration of a second period ranging from a supply start time point of a scan reference voltage to a supply start time point of a scan signal in the second subfield, and wherein the duration of the first period and the duration of the second period depend on a highest level voltage of a setup signal.

According to yet still another aspect, there is provided a plasma display apparatus comprising a plasma display panel comprising a scan electrode, and a scan driver for supplying a driving signal to the scan electrode in a first subfield and a second subfield, wherein the duration of a first period ranging from a supply end time point of a set-down signal to a supply start time point of a scan signal in the first subfield is different from the duration of a second period ranging from a supply end time point of a set-down signal to a supply start time point of a scan signal in the second subfield.

According to yet still further another aspect, there is provided a method of driving a plasma display apparatus comprising a plasma display panel comprising a scan electrode, the method comprising supplying a driving signal to the scan electrode during a first period ranging from a supply end time point of a set-down signal to a supply start time point of a scan signal in a first subfield, and supplying a driving signal to the scan electrode during a second period ranging from a supply end time point of a set-down signal to a supply start time point of a scan signal in a second subfield.

### BRIEF DESCRIPTION OF THE DRAWINGS

The embodiment of the invention will be described in detail with reference to the following drawings in which like numerals refer to like elements.

FIG. 1 illustrates a plasma display apparatus according to a first embodiment of the present invention;

FIG. 2a illustrates a plasma display panel of the plasma display apparatus according to the embodiment of the first present invention;

FIG. 2b is a diagram for enlarging a portion indicated by a reference symbol A of FIG. 2a;

FIG. 3 illustrates a frame used to represent gray scale of an image in the plasma display apparatus according to the first embodiment of the present invention;

FIG. 4 illustrates an operation of a driver of the plasma display apparatus according to the first embodiment of the present invention in one subfield;

FIG. 5 illustrates an example of a change in the duration of a period, which ranges from a supply start time point of a scan reference voltage to a supply start time point of a scan signal, in the plasma display apparatus according to the first embodiment of the present invention;

FIGS. 6a to 6h illustrate an another example of a change in the duration of a period, which ranges from a supply start time point of a scan reference voltage to a supply start time point of a scan signal, in the plasma display apparatus according to the first embodiment of the present invention;

FIG. 7 illustrates a change in the duration of a period ranging from a supply start time point of a scan reference voltage to a supply start time point of a scan signal, depending on a temperature of a plasma display panel in a plasma display apparatus according to a second embodiment of the present invention;

FIG. 8 illustrates a reason to reduce the duration of a period ranging from a supply start time point of a scan reference voltage to a supply start time point of a scan signal when the temperature of the plasma display panel is relatively high;

FIG. 9 illustrates a change in the duration of a period ranging from a supply start time point of a scan reference voltage to a supply start time point of a scan signal depending on the temperature of the plasma display panel; and

FIG. 10 illustrates the duration of a period ranging from a supply start time point of a scan reference voltage to a supply start time point of a scan signal depending on a highest level voltage of a setup signal in a plasma display apparatus according to a third embodiment of the present invention.

### DETAILED DESCRIPTION OF PREFERRED EMBODIMENTS

Embodiments of the present invention will be described in a more detailed manner with reference to the drawings.

A plasma display apparatus according to embodiments of the present invention comprises a plasma display panel comprising a scan electrode, and a scan driver for supplying a driving signal to the scan electrode in a first subfield and a second subfield, wherein the duration of a first period ranging from a supply start time point of a scan reference voltage to a supply start time point of a scan signal in the first subfield is different from the duration of a second period ranging from a supply start time point of a scan reference voltage to a supply start time point of a scan signal in the second subfield.

The first subfield may be one of a plurality of subfields, and the second subfield may be at least one of the remaining subfields.

The changes in the duration of the first period and the second period may range from about 1 μs to about 50 μs during the period when the scan signal is first supplied to a scan electrode. The scan electrode is one of a plurality of scan electrodes.

The changes in the duration of the first period and the second period may range from about 5 μs to about 15 μs during the period when the scan signal is first supplied to a scan electrode. The scan electrode is one of a plurality of scan electrodes.

A difference between the duration of the first period and the duration of the second period may range from about 1 μs to about 50 μs.

A difference between the duration of the first period and the duration of the second period may range from about 10 μs to about 30 μs.

A difference between the duration of the first period and the duration of the second period may range from about 15 μs to about 25 μs.

The duration of the first period and the duration of the second period may be inversely proportional to the duration of a falling period of a set-down signal.

The duration of the first period and the duration of the second period may be inversely proportional to a lowest level voltage of a set-down signal.

The duration of the first period and the duration of the second period may be inversely proportional to the duration of a maintenance period of a voltage at a supply end time point of a set-down signal.

The duration of the first period and the duration of the second period may be inversely proportional to the duration of a maintenance period of a voltage at a supply start time point of a set-down signal.

The duration of the first period and the duration of the second period may be inversely proportional to the duration of a rising period of a setup signal.

The duration of the first period and the duration of the second period may be inversely proportional to the duration of a maintenance period of a voltage at a supply end time point of a setup signal.

The duration of the first period and the duration of the second period may be inversely proportional to the duration of a maintenance period of a voltage at a supply start time point of a setup signal.

The shift of a supply start time point of a reset signal changes the duration of the first period and the duration of the second period.

A plasma display apparatus according to the embodiments of the present invention comprises a plasma display panel comprising a scan electrode, and a scan driver for supplying a driving signal to the scan electrode in a first subfield and a second subfield, wherein the duration of a first period ranging from a supply start time point of a scan reference voltage to a supply start time point of a scan signal in the first subfield at a first temperature is different from the duration of a second period ranging from a supply start time point of a scan reference voltage to a supply start time point of a scan signal in the second subfield at a second temperature.

When the second temperature is more than the first temperature, the duration of the second period may be less than the duration of the first period.

The first temperature and the second temperature may comprise either an internal temperature of the plasma display panel or an ambient temperature of the plasma display panel.

A plasma display apparatus according to the embodiments of the present invention comprises a plasma display panel comprising a scan electrode, and a scan driver for supplying a driving signal to the scan electrode in a first subfield and a second subfield, wherein the duration of a first period ranging from a supply start time point of a scan reference voltage to a supply start time point of a scan signal in the first subfield is different from the duration of a second period ranging from a supply start time point of a scan reference voltage to a supply start time point of a scan signal in the second subfield, and wherein the duration of the first period and the duration of the second period depend on a highest level voltage of a setup signal.

When a highest level voltage of a setup signal in the second subfield is less than a highest level voltage of a setup signal in the first subfield, the duration of the second period may be less than the duration of the first period.

A plasma display apparatus according to the embodiments of the present invention comprises a plasma display panel comprising a scan electrode, and a scan driver for supplying a driving signal to the scan electrode in a first subfield and a second subfield, wherein the duration of a first period ranging from a supply end time point of a set-down signal to a supply start time point of a scan signal in the first subfield is different from the duration of a second period ranging from a supply end time point of a set-down signal to a supply start time point of a scan signal in the second subfield.

When a temperature of the plasma display panel in the second subfield is more than a temperature of the plasma display panel in the first subfield, the duration of the second period may be less than the duration of the first period.

A method of driving a plasma display apparatus comprising a plasma display panel comprising a scan electrode according to the embodiments of the present invention, the method comprises supplying a driving signal to the scan electrode during a first period ranging from a supply end time point of a set-down signal to a supply start time point of a scan signal in a first subfield, and supplying a driving signal to the scan electrode during a second period ranging from a supply end time point of a set-down signal to a supply start time point of a scan signal in a second subfield.

When a temperature of the plasma display panel in the second subfield is more than a temperature of the plasma display panel in the first subfield, the duration of the second period may be less than the duration of the first period.

Hereinafter, exemplary embodiments of the present invention will be described in detail with reference to the attached drawings.

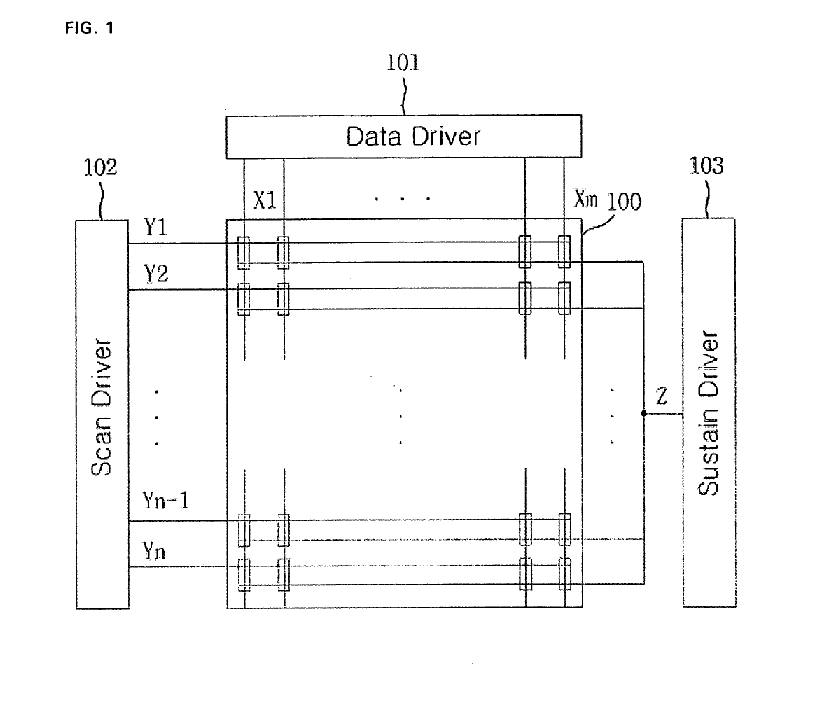

FIG. 1 illustrates a plasma display apparatus according to a first embodiment of the present invention.

Referring to FIG. 1, a plasma display apparatus according to a first embodiment of the present invention comprises a plasma display panel 100 and a scan driver 102. Further, the plasma display apparatus may comprise a data driver 101 and a sustain driver 103.

The data driver 101 supplies a data signal to address electrodes X1 to Xm of the plasma display panel 100 to drive the address electrodes X1 to Xm.

The scan driver 102 supplies a reset signal, a scan signal, and a sustain signal with a sustain voltage to scan electrodes Y1 to Yn of the plasma display panel 100 to drive the scan electrodes Y1 to Yn.

The sustain driver 103 supplies a sustain bias voltage and a sustain signal with a sustain voltage to sustain electrodes Z of the plasma display panel 100 to drive the sustain electrodes Z.

The scan driver 102 and the sustain driver 103 may be integrated with each other and may be formed on a single board. Therefore, an integrated driver for integrating the scan driver 102 and the sustain driver 103 may supply a reset signal, a scan signal and a sustain signal.

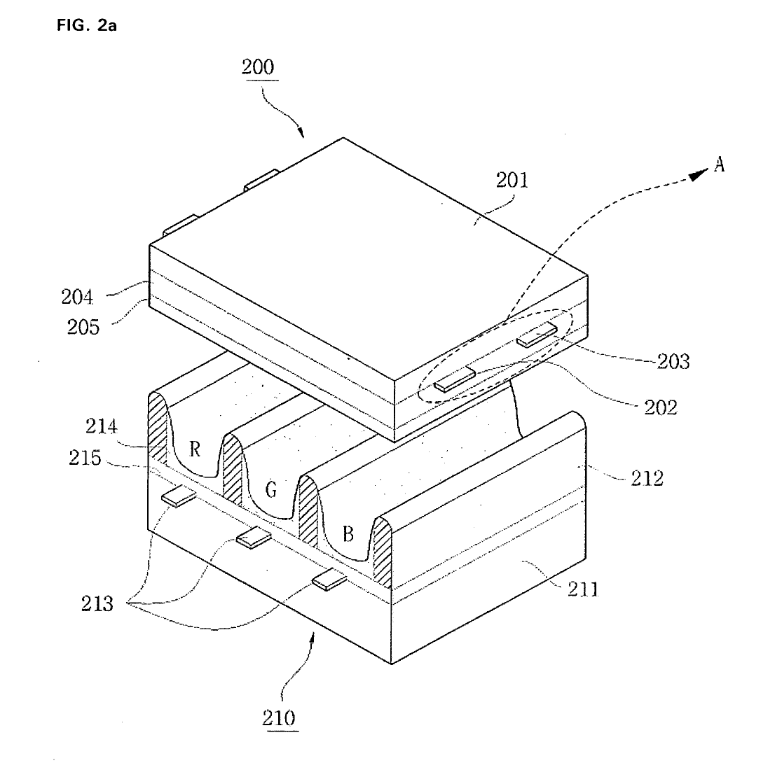

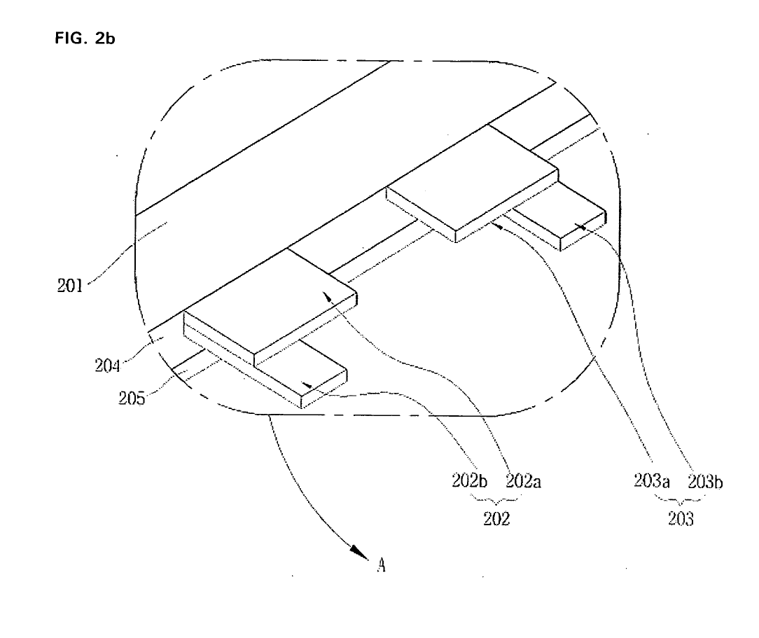

The following is a detailed description of a structure of the plasma display panel 100, with reference to FIGS. 2a and 2b.

FIG. 2a illustrates a plasma display panel of the plasma display apparatus according to the first embodiment of the present invention. FIG. 2b is a diagram for enlarging a portion indicated by a reference symbol A of FIG. 2a.

Referring to FIG. 2a, the plasma display panel comprises a front panel 200 and a rear panel 210 which are coalesced in parallel to oppose to each other at a given distance therebetween.

The front panel 200 comprises a front substrate 201 on which a scan electrode 202 and a sustain electrode 203 are formed.

The rear panel 210 comprises a rear substrate 211 on which an address electrode 213 is formed to intersect the scan electrode 202 and the sustain electrode 203.

The scan electrode 202 and the sustain electrode 203 formed on the front substrate 201 generate a mutual discharge therebetween within discharge cells for forming discharge spaces and provide a path for discharge maintenance.

An upper dielectric layer 204 is formed on an upper portion of the front substrate 201 on which the scan electrode 202 and the sustain electrode 203 are formed, thereby covering the scan electrode 202 and the sustain electrode 203.

The upper dielectric layer 204 limits a discharge current of the scan electrode 202 and the sustain electrode 203, and providing insulation between the scan electrode 202 and the sustain electrode 203.

A protective layer 205 is formed on an upper surface of the upper dielectric layer 204 to facilitate discharge conditions. The protective layer 205 is formed by depositing a material such as MgO on an upper portion of the upper dielectric layer 204.

The address electrode 213 formed on the rear substrate 211 provides a data supply path for the discharge cells.

A lower dielectric layer 215 is formed on an upper portion of the rear substrate 211 on which the address electrode 213 is formed, thereby covering the address electrode 213. The lower dielectric layer 215 provides insulation between the address electrodes 213.

A plurality of stripe-type or well-type barrier ribs 212 for forming the discharge cells are formed on an upper portion of the lower dielectric layer 215. Therefore, Red (R), green (G) and blue (B) discharge cells are formed between the front substrate 201 and the rear substrate 211.

The discharge cells formed by the barrier rib 212 are filled with a predetermined discharge gas.

A phosphor layer 214 is formed within the discharge cells to emit visible light for displaying an image during the generation of an address discharge. For example, red (R), green (G) and blue (B) phosphor layers 214 may be formed.

The plasma display apparatus according to the first embodiment of the present invention generates the discharge within the discharge cells by supplying a driving voltage to at least one of the scan electrode 202, the sustain electrode 203 or the address electrode 213.

Next, the discharge gas filled in the discharge cell generates vacuum ultraviolet rays, and the vacuum ultraviolet rays are applied to the phosphor layer 214 formed within the discharge cells.

Next, visible light is generated in the phosphor layer 214 and the visible light is emitted to the outside through the front substrate 201. Therefore, an image is displayed on an external surface of the front substrate 201

The explanation was given of an example of the scan electrode 202 and the sustain electrode 203, which comprise only one layer, in FIG. 2a. However, at least one of the scan electrode 202 and the sustain electrode 203 may comprise a plurality of layers. This will be described with reference to FIG. 2b.

Referring to FIG. 2b, the scan electrode 202 and the sustain electrode 203 each may comprise two layers.

In particular, the scan electrode 202 and the sustain electrode 203 each may comprise transparent electrodes 202a and 203a made of a transparent indium-tin-oxide (ITO) material and bus electrodes 202b and 203b made of an opaque material such as Ag, in consideration of a light transmission rate and electric conductivity.

The reason why the scan electrode 202 and the sustain electrode 203 comprise the transparent electrodes 202a and 203a is to efficiently emit the visible light generated within the discharge cell to the outside of the plasma display panel.

Further, the reason why the scan electrode 202 and the sustain electrode 203 comprise the bus electrodes 202b and 203b is to prevent a reduction in the driving efficiency. In other words, when the scan electrode 202 and the sustain electrode 203 comprise only the transparent electrodes 202a and 203a, the transparent electrodes 202a and 203a with relatively low electric conductivity causes a reduction in the driving efficiency of the plasma display apparatus. Therefore, the bus electrodes 202b and 203b compensate the low electric conductivity of the transparent electrodes 202a and 203a.

The explanation was given of an example of the plasma display panel according to the first embodiment of the present invention in FIGS. 2a and 2b. However, the plasma display panel according to the first embodiment of the present invention is not limited to the plasma display panel with the structure illustrated in FIGS. 2a and 2b.

For example, the explanation was given of an example of the upper dielectric layer 204 and the lower dielectric layer 215, which comprise only one layer, in FIGS. 2a and 2b. However, at least one of the upper dielectric layer 204 and the lower dielectric layer 215 may comprise a plurality of layers.

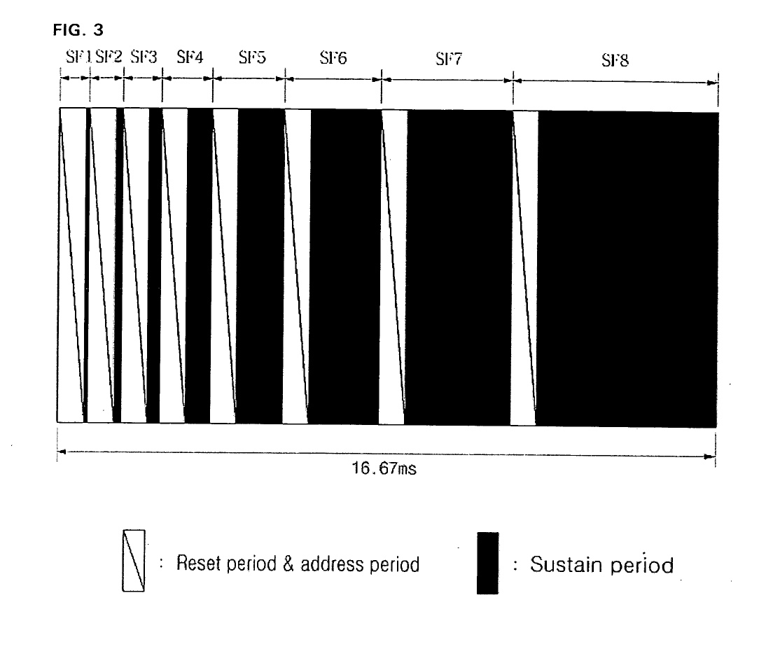

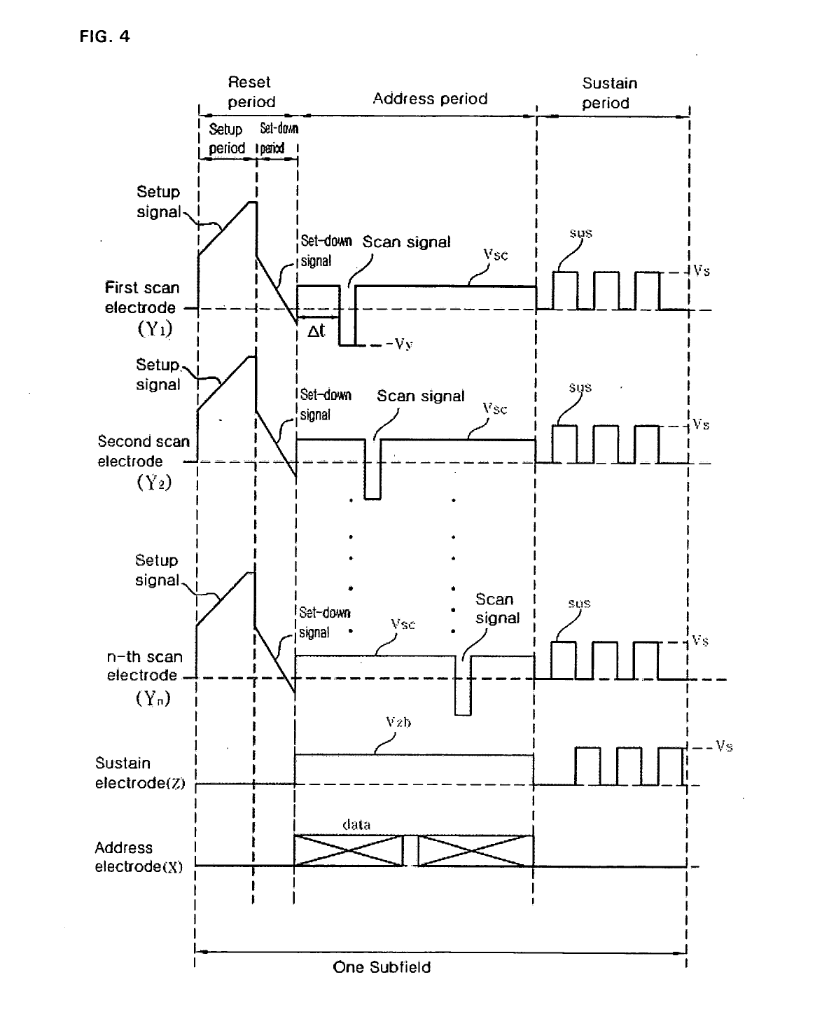

Operations of the data driver 101, the scan driver 102 and the sustain driver 103 in the plasma display apparatus according to the first embodiment of the present invention will be described with reference to FIGS. 3 and 4.

FIG. 3 illustrates a frame used to represent gray scale of an image in the plasma display apparatus according to the first embodiment of the present invention.

FIG. 4 illustrates an operation of a driver of the plasma display apparatus according to the first embodiment of the present invention in one subfield.

Referring to FIG. 3, one frame in the plasma display panel is divided into several subfields whose number of emissions are different from one another.

Although it is not illustrated in FIG. 3, each of the subfields comprises a reset period for initializing all of the discharge cells, an address period for selecting cells to be discharged and a sustain period for representing gray scale depending on number of discharges.

For example, in a case of representing 256-level gray scale, a frame period (16.67 ms) corresponding to 1/60 sec is divided into eight subfields SF1 to SF8. The eight subfields SF1 to SF8 each comprise a reset period, an address period and a sustain period.

The duration of the reset period in a subfield is equal to the duration of the reset periods in the remaining subfields. The duration of the address period in a subfield is equal to the duration of the address periods in the remaining subfields.

Gray level weight of the corresponding subfield is controlled by controlling the number of sustain signals supplied in the sustain period. In other words, gray level weight is given in each of the subfields using the sustain period.

For example, gray level weight of a first subfield is set to 2⁰, and gray level weight of a second subfield is set to 2¹. In other words, the sustain period increases in a ratio of 2ⁿ (n=0, 1, 2, 3, 4, 5, 6, 7) in each of the subfields.

As described above, various images are displayed by controlling the number of sustain signals supplied in the sustain period of each of the subfields depending on gray level weight in each of the subfields.

The plasma display apparatus according to the first embodiment of the present invention uses a plurality of frames to display an image during 1 second. For example, 60 frames are used to display an image during 1 second.

The explanation was given of an example of one frame comprising 8 subfields in FIG. 3. However, the number of subfields included in one frame may change.

For example, one frame may comprise 12 subfields. Further, one frame may comprise 10 subfields.

Image quality of the plasma display apparatus for representing gray scale of the image using the frame is controlled by the number of subfields included in the frame.

When one frame comprises twelve subfields, gray scale of 2¹¹ images can be represented. When one frame comprises eight subfields, gray scale of 2⁷ images can be represented.

Moreover, the several subfields of one frame were arranged in ascending order of gray level weight in FIG. 3. However, the several subfields may be arranged in descending order of gray level weight. Further, the several subfields may be arranged irrespective of gray level weight.

An example of operations of the plasma display apparatus in one subfield of the plurality of subfields included in the frame of FIG. 3 is illustrated in FIG. 4.

Referring to FIG. 4, one subfields may comprise a reset period comprising a setup period and a set-down period, an address period, and a sustain period.

Although it is not illustrated in FIG. 4, a signal supply period for erasing wall charges within the discharge cells is included between the reset period and the address period.

The scan driver 102 supplies a setup signal with a gradually rising signal to all of the scan electrodes Y1 to Yn in the setup period of the reset period.

The setup signal generates a weak dark discharge, that is, a setup discharge within the discharge cells. The setup discharge accumulates a proper quantity of wall charges within the discharge cells.

The scan driver 102 supplies a set-down signal, which gradually falls from a voltage less than a peak voltage of the setup signal, to all of the scan electrodes Y1 to Yn in the set-down period of the reset period.

The set-down signal generates a weak erasure discharge, that is, a set-down discharge within the discharge cells.

The set-down discharge sufficiently erases the wall charges excessively accumulated within the discharge cells by the setup discharge. As a result, the wall charges uniformly remain within the discharge cells to the degree that there is the generation of a stable address discharge.

The scan driver 102 sequentially supplies a scan reference voltage Vsc and a scan signal, which falls from the scan reference voltage Vsc to a negative scan voltage −Vy, to all of the scan electrodes Y1 to Yn in the address period which follows the reset period.

For example, the scan driver 102 supplies a first scan signal to the first scan electrode Y1 and supplies a n-th scan signal to the n-th scan electrode Yn

Further, the scan driver 102 may randomly supply the scan signal to all of the scan electrodes Y1 to Yn.

For example, after the scan signal may be sequentially supplied to all of the even-numbered scan electrodes, the scan signal may be sequentially supplied to all of the odd-numbered scan electrodes. Further, the scan signal may be supplied irrespective of the order of the scan signal.

The explanation was given of an example where the scan driver 102 supplies the scan reference voltage Vsc and the scan signal in the address period in FIG. 4.

However, the scan driver 102 may supply a scan bias voltage being a sum of the scan reference voltage Vsc and the negative scan voltage −Vy. The scan driver 102 may supply the scan signal which falls from the scan bias voltage to the negative scan voltage −Vy.

The scan driver 102 supplies a driving signal to the scan electrode Y in the first subfield and the second subfield. A first period ranges from a supply start time point of the scan reference voltage Vsc to a supply start time point of the scan signal in the first subfield. A second period ranges from a supply start time point of the scan reference voltage Vsc to a supply start time point of the scan signal in the second subfield. The duration of the first period and the duration of the second period are different from each other.

For example, as illustrated in FIG. 4, when a first scan signal is supplied to the first scan electrode Y1, the scan driver 102 supplies the driving signal to the first scan electrode Y1 in the first period and the second period whose the durations are different from each other.

The first subfield is one of the plurality of subfields. The second subfield is at least one of the remaining subfields.

Further, the first subfield is included in one of the plurality of frames. The second subfield is included in at least one of the remaining frames.

When the first subfield and the second subfield are included in the difference frames, gray level weights of the first subfield and the second subfield may be equal to each other or may be different from each other.

When the first scan signal is supplied to the first scan electrode Y1, the duration of a period Δt, which ranges from a supply start time point of the scan reference voltage Vsc to a supply start time point of the first scan signal, changes. As a result, when the remaining scan signals are sequentially supplied to the remaining scan electrodes Y2 to Yn, the durations of periods ranging from a supply start time point of the scan reference voltage Vsc to a supply start time point of each of the remaining scan signals may change.

When the scan driver 102 supplies the scan signal with the negative scan voltage −Vy to the scan electrode Y1 to Yn, the data driver 101 supplies a data signal corresponding to the scan signal to the address electrode X.

The sustain driver 103 supplies a sustain bias voltage Vzb to the sustain electrode Z in the address period to prevent an erroneous discharge caused by the interference of the sustain electrode Z.

While a difference between the negative scan voltage −Vy of the scan signal and a voltage of the data signal is added to a wall voltage of the wall charges produced during the reset period, the address discharge is generated within the discharge cells to which the data signal is supplied.

The wall charges necessary for a sustain discharge when supplying the sustain voltage Vs of the sustain signal are formed within the discharge cells selected by performing the address discharge.

The scan driver 102 and the sustain driver 103 supply a sustain signal sus to at least one of the scan electrode Y and the sustain electrode Z in the sustain period which follows the address period.

In FIG. 4, the scan driver 102 and the sustain driver 103 alternately supply the sustain signal sus to the scan electrode Y and the sustain electrode Z.

Further, different from FIG. 4, the scan driver 102 and the sustain driver 103 may alternately supply the sustain signal sus, which swings from a voltage of Vs/2 to a voltage of −Vs/2, to the scan electrode Y and the sustain electrode Z.

Further, when the scan driver 102 and the sustain driver 103 are integrated, an integrated driver may supply the sustain signal sus to the scan electrode Y or the sustain electrode Z.

As described above, when the integrated driver may supply the sustain signal sus to the scan electrode Y or the sustain electrode Z, the swing width of the sustain signal sus may range from a voltage of Vs to a voltage of −Vs.

While the wall voltage within the discharge cells selected by performing the address discharge is added to the sustain voltage Vs of the sustain signal sus, a sustain discharge, that is, a display discharge, is generated between the scan electrode Y and the sustain electrode Z whenever the sustain signal sus is supplied. As a result, a predetermined image is displayed on the plasma display panel.

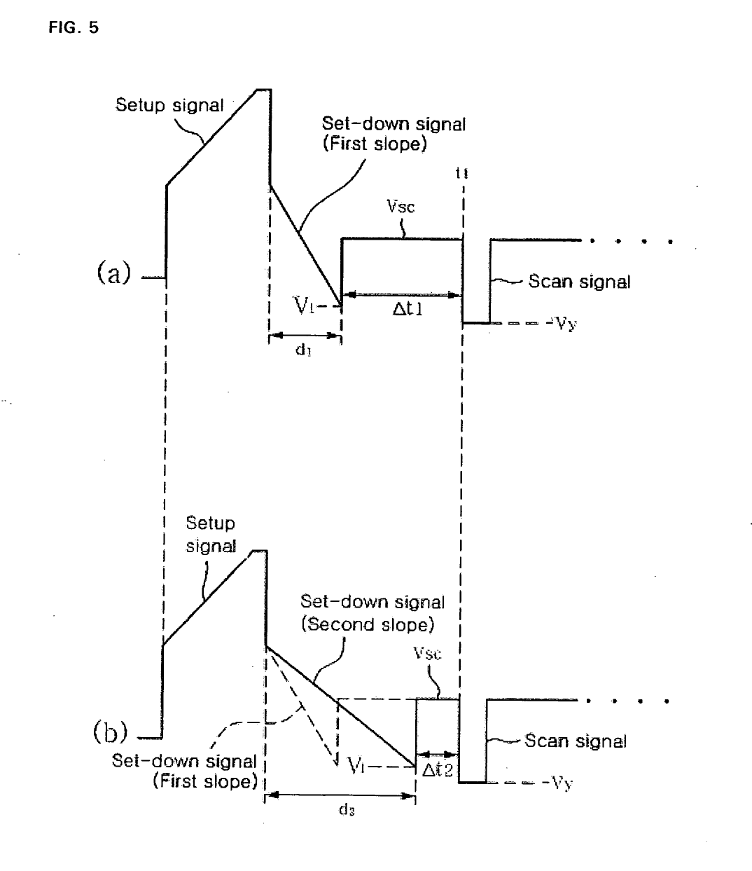

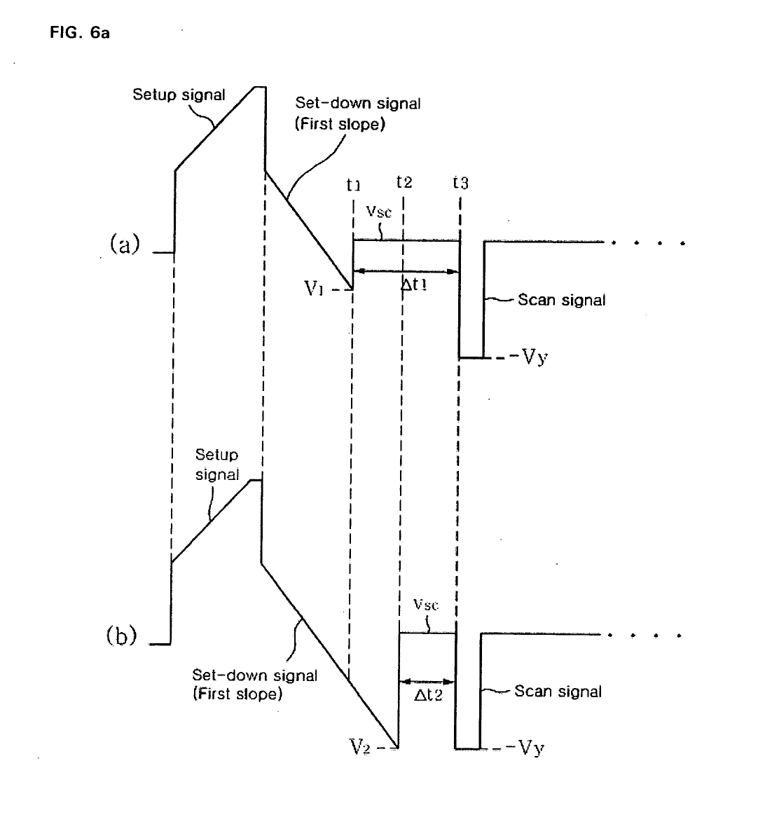

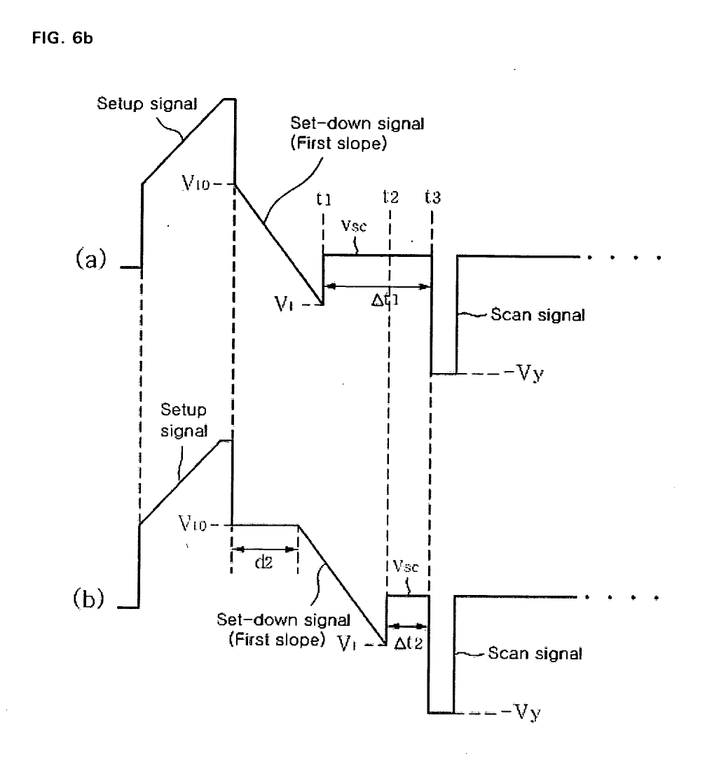

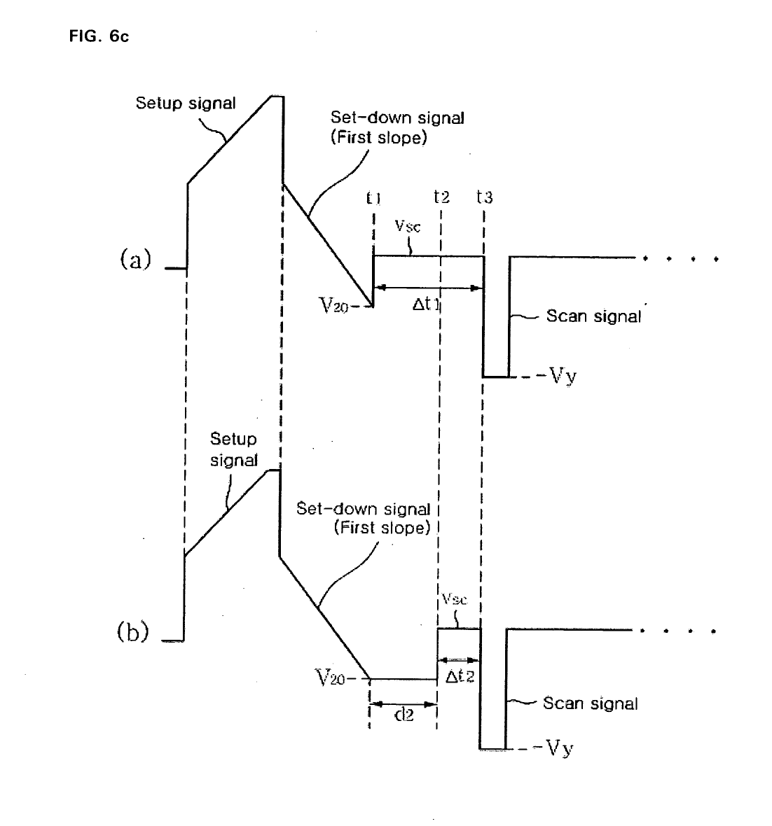

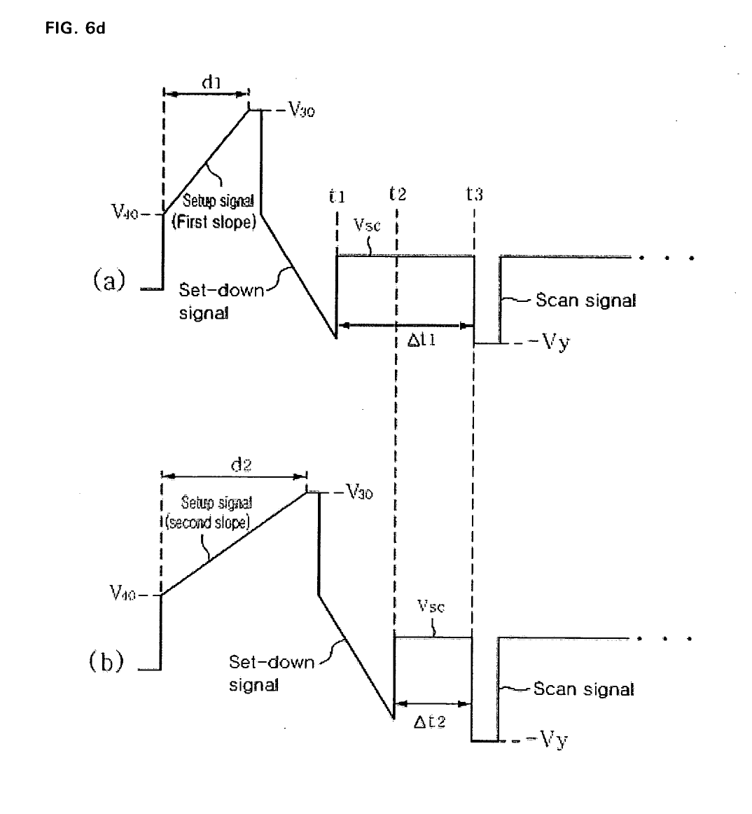

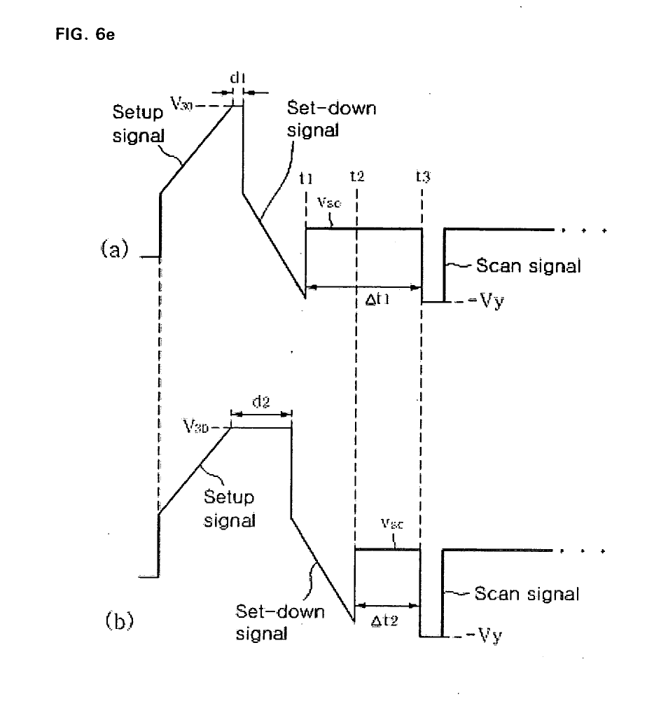

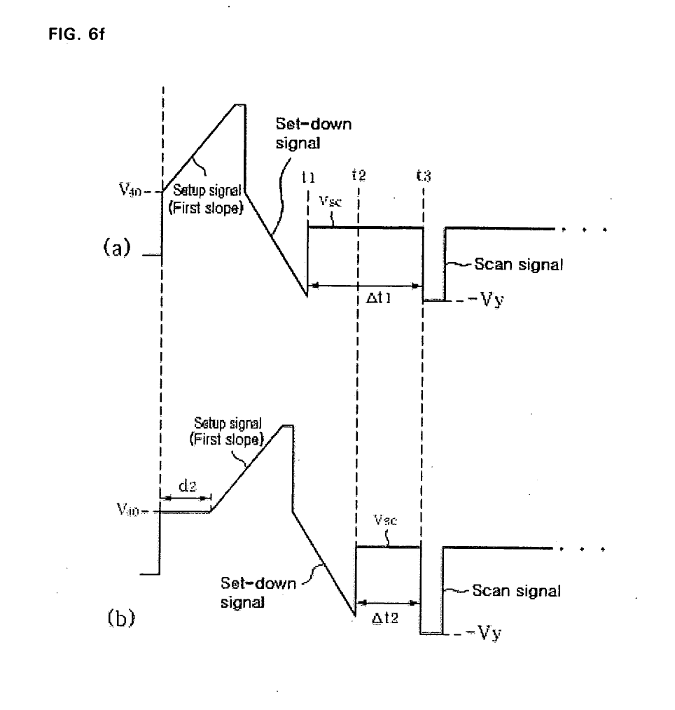

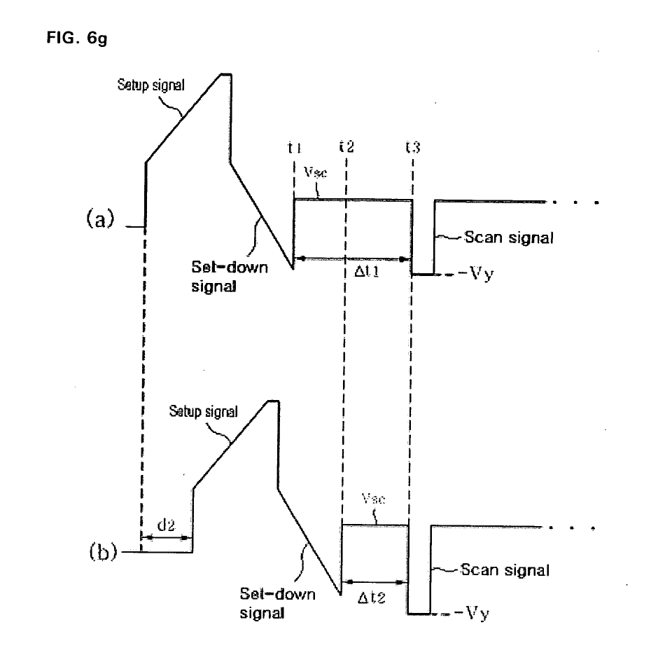

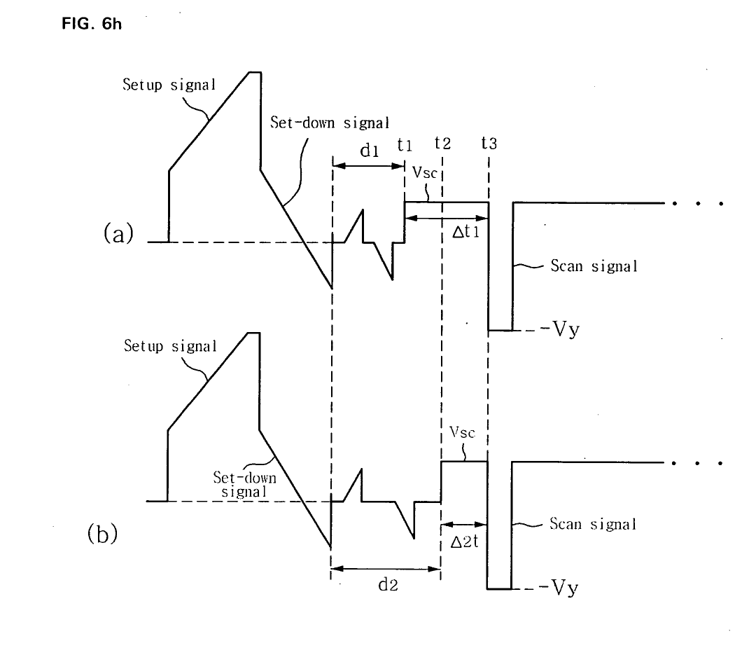

A change in the duration of the period Δt, which ranges from the supply start time point of the scan reference voltage Vsc to the supply start time point of the scan signal, will be described with reference to FIG. 5 and FIGS. 6a to 6h.

FIG. 5 illustrates an example of a change in the duration of a period, which ranges from a supply start time point of a scan reference voltage to a supply start time point of a scan signal, in the plasma display apparatus according to the first embodiment of the present invention.

FIGS. 6a to 6h illustrate an another example of a change in the duration of a period, which ranges from a supply start time point of a scan reference voltage to a supply start time point of a scan signal, in the plasma display apparatus according to the first embodiment of the present invention.

As illustrated in FIG. 5, the duration of the first period and the duration of the second period are inversely proportional to the duration of a falling period of the set-down signal.

More specifically, by supplying in the second subfield the set-down signal with a slope gentler than a slope of the set-down signal in the first subfield, the duration of the falling period of the set-down signal in the second subfield is more than the duration of the falling period of the set-down signal in the first subfield.

When the duration of the falling period of the set-down signal is lengthen, the duration of a period, which ranges from a supply start time point of the scan reference voltage Vsc to a supply start time point t1 of the scan signal, decreases.

The supply time point t1 of the scan signal in the first subfield as illustrated in (a) of FIG. 5 approximately equals to the supply time point t1 of the scan signal in the second subfield as illustrated in (b) of FIG. 5. Further, a lowest voltage V1 of the set-down signal at a supply end time point of the set-down signal in the first subfield approximately equals to a lowest voltage V1 of the set-down signal at a supply end time point of the set-down signal in the second subfield. At this time, the driving signal is supplied to the same scan electrode in the first subfield and the second subfield.

As illustrated in (a) of FIG. 5, when the slope of the set-down signal in the first subfield is set to the first slope, the first period ranging from the supply start time point of the scan reference voltage Vsc to a supply start time point t1 of the scan signal is set to Δt1.

As illustrated in (b) of FIG. 5, when the slope of the set-down signal in the second subfield is set to the second slope gentler than the first slope, that is, when the duration of the falling period of the set-down signal is lengthen, the second period ranging from a supply start time point t2 of the scan reference voltage Vsc to the supply start time point t1 of the scan signal is set to Δt2 shorter than Δt1.

As a result, the scan driver 102 supplies the driving signal, in which the duration of the supply period of the set-down signal equals to d1 and the duration of the first period equals to Δt1, to the scan electrode Y in the first subfield. Further, the scan driver 102 supplies the driving signal, in which the duration of the supply period of the set-down signal equals to d2 longer than d1 and the duration of the first period equals to Δt2 shorter than Δt1, to the scan electrode Y, which equals to the scan electrode Y supplied in the first subfield, in the second subfield.

The explanation was given of an example, where the supply start time point of the scan signal equals to t1, in FIG. 5. However, the supply start time point t1 of the scan signal may change.

Hereinafter, an example where the supply time point of the scan signal in the first subfield equals to the supply time point of the scan signal in the second subfield, will be described for convenience of the explanation.

A reason why the duration of the period ranging from the supply start time point of the scan reference voltage Vsc to the supply start time point t1 of the scan signal changes is as follows.

For example, referring to FIG. 4, the scan signal is supplied to the first scan electrode Y1 after the lapse of time of Δt from the supply start time point of the scan reference voltage Vsc.

In other words, the scan signal is supplied to the first scan electrode Y1 after the lapse of time of Δt from a supply end time point of the discharge generated by the set-down signal in the reset period.

With the lapse of time, the wall charges produced by the discharge generated by the set-down signal in the reset period are combined with space charges having a space within the discharge cells, such that the wall charges are neutralized.

Accordingly, when the duration of the period Δt changes after the set-down signal generates the discharge, the distribution of the wall charges within the discharge cells at the supply start time point of the scan signal changes.

For example, after the set-down signal generates the discharge, the quantity of wall charges after the lapse of 5 μs is more than the quantity of wall charges after the lapse of 15 μs.

Accordingly, by controlling the duration of the period At ranging from the supply start time point of the scan reference voltage Vsc to the supply start time point of the scan signal, the distribution of the wall charges within the discharge cells can be controlled at the supply start time point t1 of the scan signal, that is, at a generation start time point of the address discharge.

For example, when an excessively large quantity of wall charges are produced within the discharge cells at the time point t1, the intensity of the address discharge generated by the scan signal and the data signal excessively increases. In other words, the address discharge with the excessively great intensity is generated such that an erroneous address discharge is generated.

In such a case, as illustrated in (a) of FIG. 5, by increasing the duration of the period Δt1 ranging from the supply start time point of the scan reference voltage Vsc to the supply start time point t1 of the scan signal, the quantity of wall charges within the discharge cells sufficiently decreases at the time point t1 such that the erroneous address discharge is prevented.

On the other hand, when an excessively small quantity of wall charges are produced within the discharge cells at the time point t1, the intensity of the address discharge becomes excessively weak. In other words, the address discharge with the excessively weak intensity is generated such that an erroneous address discharge is generated.

In such a case, as illustrated in (b) of FIG. 5, by decreasing the duration of the period Δt2 ranging from the supply start time point of the scan reference voltage Vsc to the supply start time point t1 of the scan signal, the quantity of wall charges within the discharge cells sufficiently increases at the time point t1 such that the erroneous address discharge is prevented.

The change in the duration of the falling period of the set-down signal changes the duration of the period At ranging from the supply start time point of the scan reference voltage Vsc to the supply start time point t1 of the scan signal.

Further, other factors in the reset period may change the duration of the period.

The following is a detailed description of the changes in the duration of the period Δt, with reference to FIGS. 6a to 6h.

As illustrated in FIG. 6a, the duration of the first period and the duration of the second period are inversely proportional to the lowest level voltage of the set-down signal in the reset period.

More specifically, when a slope of the set-down signal in the first subfield as illustrated in (a) of FIG. 6a equals to a slope of the set-down signal in the second subfield as illustrated in (b) of FIG. 6a, the duration of the falling period of the set-down signal increases by increasing a magnitude of the lowest voltage of the set-down signal from V1 to V2.

In such a case, the supply start time point of the scan reference voltage Vsc is changed from t1 in the first subfield to t2 in the second subfield.

Accordingly, the duration of the period Δt2 ranging from the supply start time point t2 of the scan reference voltage Vsc to the supply start time point t3 of the scan signal in the second subfield is less than the duration of the period Δt1 in the first subfield.

Finally, the scan driver 102 supplies the driving signal in which the lowest voltage of the set-down signal equals to V1 and the first period equals to Δt1 in the first subfield, and the driving signal in which the lowest voltage of the set-down signal equals to V2 and the second period equals to Δt2 with the duration less than the duration of the first period Δt1 less than the first period in the second subfield, to the scan electrode Y.

Next, as illustrated in FIG. 6b, the duration of the first period and the duration of the second period are inversely proportional to the duration of a maintenance period of a voltage at a supply start time point of the set-down signal.

In other words, the longer the duration of the maintenance period of the voltage at the supply start time point of the set-down signal is, the shorter the duration of the period ranging from the supply start time point of the scan reference voltage Vsc to the supply start time point of the scan signal is.

When a voltage V10 at the supply start time point, the slope (the first slope), and the lowest voltage V1 in the set-down signal of the first subfield as illustrated in (a) of FIG. 6b equal to a voltage V10 at the supply start time point, the slope (the first slope), and the lowest voltage V1 in the set-down signal of the second subfield as illustrated in (b) of FIG. 6b, the duration of the maintenance period of the voltage at the supply start time point of the set-down signal changes, and the duration of the period ranging from the supply start time point of the scan reference voltage Vsc to the supply start time point t3 of the scan signal changes.

More specifically, as illustrated in (a) of FIG. 6b, when a supply end time point of the set-down signal in the first subfield is set to t1, the first period ranging from the supply start time point t1 of the scan reference voltage Vsc to the supply start time point t3 of the scan signal equals to Δt1.

On the other hand, as illustrated in (b) of FIG. 6b, when a maintenance period of the voltage V10 at the supply start time point of the set-down signal in the second subfield is set to d2, a supply end time point of the set-down signal is set to t2. As a result, the second period ranging from the supply start time point t2 of the scan reference voltage Vsc to the supply start time point t3 of the scan signal equals to Δt2 with the duration less than the duration of the first period Δt1.

Finally, the scan driver 102 supplies the driving signal in which the maintenance period of the voltage V10 at the supply start time point of the set-down signal does not exist and the first period equals to Δt1 in the first subfield, and the driving signal in which the maintenance period of the voltage V10 at the supply start time point of the set-down signal equals to d2 and the second period equals to Δt2 with the duration less than the duration of the first period Δt1 in the second subfield, to the scan electrode Y.

Next, as illustrated in FIG. 6c, the duration of the first period and the duration of the second period are inversely proportional to the duration of a maintenance period of a voltage at a supply end time point of the set-down signal.

In other words, the longer the duration of the maintenance period of the voltage at the supply end time point of the set-down signal is, the shorter the duration of the period ranging from the supply start time point of the scan reference voltage Vsc to the supply start time point of the scan signal is.

When the supply start time point t3 of the scan signal, the slope (the first slope) of the set-down signal, and the lowest voltage V1 of the set-down signal in the first subfield as illustrated in (a) of FIG. 6c approximately equal to the supply start time point t3 of the scan signal, the slope (the first slope) of the set-down signal, and the lowest voltage V1 of the set-down signal in the second subfield as illustrated in (b) of FIG. 6c, the duration of the maintenance period of the voltage at the supply end time point of the set-down signal changes and the duration of the period ranging from the supply start time point of the scan reference voltage Vsc to the supply start time point t3 of the scan signal changes.

More specifically, as illustrated in (a) of FIG. 6c, when a supply end time point of the set-down signal in the first subfield is set to t1, the first period ranging from the supply start time point t1 of the scan reference voltage Vsc to the supply start time point t3 of the scan signal equals to Δt1.

On the other hand, as illustrated in (a) of FIG. 6c, when a maintenance period of a lowest voltage V20 of the set-down signal in the second subfield is set to d2, a supply end time point of the set-down signal is set to t2. As a result, the second period ranging from the supply start time point t2 of the scan reference voltage Vsc to the supply start time point t3 of the scan signal equals to Δt2 with the duration less than the duration of the first period Δt1.

Finally, the scan driver 102 supplies the driving signal in which the maintenance period of the voltage at the supply end time point of the set-down signal does not exist and the first period equals to Δt1 in the first subfield, and the driving signal in which the maintenance period of the lowest voltage V20 of the set-down signal equals to d2 and the second period equals to Δt2 with the duration less than the duration of the first period Δt1 in the second subfield, to the scan electrode Y.

As illustrated in FIG. 6d, the duration of the first period and the duration of the second period are inversely proportional to the duration of a rising period of the setup signal in the reset period.

In other words, the longer the duration of the rising period of the setup signal is, the shorter the duration of the period ranging from the supply start time point of the scan reference voltage Vsc to the supply start time point of the scan signal is.

When a voltage V40 at the supply start time point of the set-down signal and a highest voltage V30 of the set-down signal and the setup signal in the first subfield as illustrated in (a) of FIG. 6d equal to a voltage V40 at the supply start time point of the setup signal and a highest voltage V30 of the set-down signal and the setup signal in the second subfield as illustrated in (b) of FIG. 6d, a slope of the setup signal changes and the duration of the period ranging from the supply start time point of the scan reference voltage Vsc to the supply start time point t3 of the scan signal changes.

More specifically, as illustrated in (a) of FIG. 6d, when a slope of the setup signal in the first subfield is set to a first slope, the rising period of the setup signal is set to d1 and the first period ranging from the supply start time point t1 of the scan reference voltage Vsc to the supply start time point t3 of the scan signal equals to Δt1.

On the other hand, as illustrated in (b) of FIG. 6d, when a slope of the setup signal in the first subfield is set to a second slope gentler less than the first slope, the rising period of the setup signal is set to d2 with the duration longer than the duration of the rising period d1 and the second period ranging from the supply start time point t2 of the scan reference voltage Vsc to the supply start time point t3 of the scan signal equals to Δt2 with the duration less than the duration of the first period Δt1.

Finally, when the slope of the setup signal is changeable, the duration of the period ranging from the supply start time point of the scan reference voltage Vsc to the supply start time point t3 of the scan signal decreases by relatively decreasing the slope of the setup signal.

As illustrated in FIG. 6e, the duration of the first period and the duration of the second period are inversely proportional to the duration of a maintenance period of a voltage at a supply end time point of the setup signal in the reset period.

In other words, the longer the duration of a maintenance period of a voltage at the supply end time point of the setup signal is, the shorter the duration of the period ranging from the supply start time point of the scan reference voltage Vsc to the supply start time point of the scan signal is.

When a voltage at the supply start time point of the setup signal, a highest voltage V30 of the set-down signal and the setup signal, and the slope of the setup signal in the first subfield as illustrated in (a) of FIG. 6e equal to a voltage at the supply start time point of the setup signal, a highest voltage V30 of the set-down signal and the setup signal, and the slope of the setup signal in the second subfield as illustrated in (b) of FIG. 6e, the maintenance period of the voltage V30 at the supply end time point of the setup signal is changed from d1 to d2 and the duration of the period ranging from the supply start time point of the scan reference voltage Vsc to the supply start time point t3 of the scan signal changes.

More specifically, as illustrated in (a) of FIG. 6e, when the maintenance period of the voltage V30 at the supply end time point of the setup signal in the first subfield is set to d1, the first period ranging from the supply start time point t1 of the scan reference voltage Vsc to the supply start time point t3 of the scan signal equals to Δt1.

On the other hand, as illustrated in (b) of FIG. 6e, when the maintenance period of the voltage V30 at the supply end time point of the setup signal in the second subfield is set to d2 with the duration longer than the duration of the maintenance period d1, the second period ranging from the supply start time point t2 of the scan reference voltage Vsc to the supply start time point t3 of the scan signal equals to Δt2 with the duration less than the duration of the first period Δt1.

Finally, when the duration of the maintenance period of the voltage at the supply end time point of the setup signal is changeable, the duration of the period ranging from the supply start time point of the scan reference voltage Vsc to the supply start time point t3 of the scan signal decreases by relatively increasing the duration of the maintenance period of the voltage at the supply end time point of the setup signal.

As illustrated in FIG. 6f, the duration of the first period and the duration of the second period are inversely proportional to the duration of a maintenance period of a voltage at a supply start time point of the setup signal in the reset period.

In other words, the longer the duration of a maintenance period of a voltage at the supply start time point of the setup signal is, the shorter the duration of the period ranging from the supply start time point of the scan reference voltage Vsc to the supply start time point of the scan signal is.

When a voltage V40 at the supply start time point of the setup signal, a highest voltage of the set-down signal and the setup signal, and the slope of the setup signal in the first subfield as illustrated in (a) of FIG. 6f equal to a voltage V40 at the supply start time point of the setup signal, a highest voltage of the set-down signal and the setup signal, and the slope of the setup signal in the second subfield as illustrated in (b) of FIG. 6f, the maintenance period of the voltage V40 at the supply start time point of the setup signal changes and the duration of the period ranging from the supply start time point of the scan reference voltage Vsc to the supply start time point t3 of the scan signal changes.

More specifically, as illustrated in (a) of FIG. 6f, when the maintenance period of the voltage V40 at the supply start time point of the setup signal in the first subfield does not exist, the first period ranging from the supply start time point t1 of the scan reference voltage Vsc to the supply start time point t3 of the scan signal equals to Δt1.

On the other hand, as illustrated in (b) of FIG. 6f, when the maintenance period of the voltage V40 at the supply start time point of the setup signal in the second subfield is set to d2, the second period ranging from the supply start time point t2 of the scan reference voltage Vsc to the supply start time point t3 of the scan signal equals to Δt2 with the duration less than the duration of the first period Δt1.

Finally, when the duration of the maintenance period of the voltage at the supply start time point of the setup signal is changeable, the duration of the period ranging from the supply start time point of the scan reference voltage Vsc to the supply start time point t3 of the scan signal decreases by relatively increasing the duration of the maintenance period of the voltage at the supply start time point of the setup signal.

As illustrated in FIG. 6g, the shift of a supply start time point of the reset signal in the reset period changes the duration of the first period and the duration of the second period.

When the reset signal supplied in the first subfield as illustrated in (a) of FIG. 6g equals to the reset signal supplied in the second subfield as illustrated in (b) of FIG. 6g, the supply start time point of the reset signal is shifted by the duration of a period d2 and the duration of the period ranging from the supply start time point of the scan reference voltage Vsc to the supply start time point t3 of the scan signal changes.

More specifically, when the supply start time point of the reset signal in the first subfield is set as illustrated in (a) of FIG. 6g, the first period ranging from the supply start time point t1 of the scan reference voltage Vsc to the supply start time point t3 of the scan signal equals to Δt1.

On the other hand, as illustrated in (b) of FIG. 6g, when the supply start time point of the reset signal in the second subfield is shifted by the period d2, the second period ranging from the supply start time point t2 of the scan reference voltage Vsc to the supply start time point t3 of the scan signal equals to Δt2 with the duration less than the duration of the first period Δt1.

Finally, when the supply start time point of the reset signal is changeable, the supply start time point of the reset signal is shifted such that the duration of the period ranging from the supply start time point of the scan reference voltage Vsc to the supply start time point t3 of the scan signal relatively decreases.

As illustrated in FIG. 6h, when a stabilization period, where a signal for reducing the wall charges is supplied, is added between the supply end time point of the reset period and the supply start time point of the address period, the duration of the period ranging from the supply start time point of the scan reference voltage Vsc to the supply start time point t3 of the scan signal changes by changing the duration of the stabilization period.

For example, as illustrated in (a) and (b of FIG. 6h, a stabilization periods d1 and d2, where a signal for properly reducing the wall charges is supplied to the scan electrode Y, may be added between the reset period and the address period.

When the stabilization period exists, the period ranging from the supply start time point of the scan reference voltage Vsc to the supply start time point t3 of the scan signal is changed from Δt1 to Δt1 by changing the duration of the stabilization period from d1 to d2. In other words, the duration of the period ranging from the supply start time point of the scan reference voltage Vsc to the supply start time point t3 of the scan signal decreases by relatively increasing the duration of the stabilization period.

Different from the signal illustrated in FIG. 6h, the signal in the stabilization period may be alternately supplied to the scan electrode and the sustain electrode. Further, the signal in the stabilization period may be supplied in the form of a square wave other than a ramp form.

The duration of the period ranging from the supply start time point of the scan reference voltage Vsc to the supply start time point t3 of the scan signal changes by various methods.

The duration of the period ranging from the supply start time point of the scan reference voltage Vsc to the supply start time point t3 of the scan signal is changeable by combining the above-described examples.

The explanation was given of examples of a change in the supply start time point of the scan reference voltage Vsc in a case where the duration of the period ranging from the supply start time point of the scan reference voltage Vsc to the supply start time point t3 of the scan signal changes. However, the supply start time point t3 of the scan signal may change.

When the supply start time point of the scan reference voltage Vsc changes, the sustain bias voltage Vzb synchronized with the scan reference voltage Vsc supplied to the scan electrode may be supplied to the sustain electrode.

The changes in the duration of the first period and the second period range from about 1 μs to about 50 μs during the period when the scan signal is first supplied to a scan electrode. At this time, the scan electrode is one of a plurality of scan electrodes.

For example, when the scan signal is sequentially supplied to the first to n-th scan electrodes Y1 to Yn as illustrated in FIG. 4, the changes in the duration of the first period and the second period of the driving signal supplied to the first scan electrode Y1 ranges from 1 μs to about 50 μs.

Further, when the scan signal is randomly supplied to the scan electrodes in no particular order, the changes in the duration of the first period and the second period range from about 1 μs to about 50 μs during the period when the scan signal is first supplied to a scan electrode. At this time, the scan electrode is one of a plurality of scan electrodes.

Since the duration of the first period and the second period changes in the range of about 1 μs or more, a period for efficiently controlling the quantity of wall charges within the discharge cells is secured and a period for performing the stable address discharge is also secured.

Since the duration of the first period and the duration of the second period change in the range of about 50 μs or less, a period for efficiently controlling the quantity of wall charges within the discharge cells is secured and a minimum margin for a driving period of the driving signal is also secured.

The changes in the duration of the first period and the second period range from about 5 μs to about 15 μs during the period when the scan signal is first supplied to a scan electrode. At this time, the scan electrode is one of a plurality of scan electrodes.

Since the duration of the first period and the duration of the second period change in the range of about 5 μs or more, a period for more efficiently controlling the quantity of wall charges within the discharge cells is secured under the various conditions such as a pressure, a temperature, a mixed state of a gas within the plasma display panel and a period for performing the more stable address discharge is also secured.

Since the duration of the first period and the duration of the second period change in the range of about 15 μs or less, a period for more efficiently controlling the quantity of wall charges within the discharge cells is secured under the various conditions such as a pressure, a temperature, a mixed state of a gas within the plasma display panel and a proper margin for a driving period of the driving signal is also secured.

A difference between the duration of the first period and the duration of the second period ranges from about 1 us to about 50 μs.

Since the difference between the duration of the first period and the duration of the second period is about 1 μs or more, the minimum duration of a period for controlling the quantity of wall charges within the discharge cells is secured.

Since the difference between the duration of the first period and the duration of the second period is about 50 μs or less, a period for controlling the quantity of wall charges within the discharge cells is secured and a minimum driving margin for a driving period of the driving signal is also secured.

Preferably, a difference between the duration of the first period and the duration of the second period ranges from about 5 μs to about 30 μs.

Since the difference between the duration of the first period and the duration of the second period is about 5 μs or more, a period for efficiently controlling the quantity of wall charges within the discharge cells is secured. Since the difference between the duration of the first period and the duration of the second period is about 30 μs or less, a proper driving margin for all of the driving periods is secured and the quantity of wall charges is properly controlled.

More preferably, a difference between the duration of the first period and the duration of the second period ranges from about 10 μs to about 25 μs.

Since the difference between the duration of the first period and the duration of the second period is about 10 μs or more, a period for more efficiently controlling the quantity of wall charges within the discharge cells is secured. Since the difference between the duration of the first period and the duration of the second period is about 25 μs or less, a more proper driving margin is secured and the quantity of wall charges is more properly controlled.

The duration of the period ranging from the supply start time point of the scan reference voltage Vsc to the supply start time point t3 of the scan signal changes depending on a temperature of the plasma display panel.

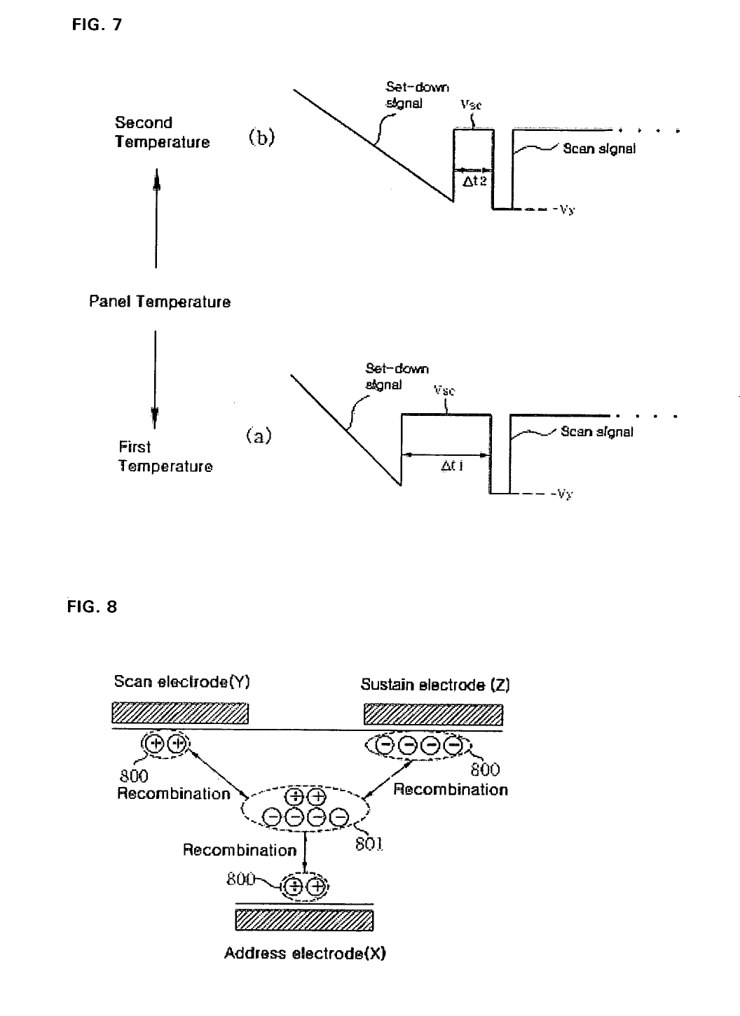

FIG. 7 illustrates a change in the duration of a period ranging from a supply start time point of a scan reference voltage to a supply start time point of a scan signal, depending on a temperature of a plasma display panel in a plasma display apparatus according to a second embodiment of the present invention.

A plasma display apparatus according to a second embodiment of the present invention comprises a plasma display panel comprising a scan electrode, and a scan driver for supplying a driving signal to the scan electrode in a first subfield and a second subfield. The duration of a first period ranging from a supply start time point of a scan reference voltage to a supply start time point of a scan signal in the first subfield at a first temperature is different from the duration of a second period ranging from a supply start time point of a scan reference voltage to a supply start time point of a scan signal in the second subfield at a second temperature.

The first temperature and the second temperature comprise either an internal temperature of the plasma display panel or an ambient temperature of the plasma display panel.

When the second temperature is more than the first temperature, the duration of the second period is less than the duration of the first period.

Referring to FIG. 7, when the temperature of the plasma display panel is the first temperature and the first temperature and the second temperature are different from each other, the duration of the period ranging from the supply start time point of the scan reference voltage Vsc to the supply start time point of the scan signal changes.

For example, as illustrated in (a) of FIG. 7, when the temperature of the plasma display panel is the first temperature in the first subfield, the first period ranging from the supply start time point of the scan reference voltage Vsc to the supply start time point of the scan signal is set to Δt1.

As illustrated in (b) of FIG. 7, when the temperature of the plasma display panel is the second temperature more than the first temperature in the second subfield, the second period ranging from the supply start time point of the scan reference voltage Vsc to the supply start time point of the scan signal is set to Δt2 with the duration less than the duration of the first period Δt1.

Since the higher the temperature of the plasma display panel is, the shorter the duration of the period ranging from the supply start time point of the scan reference voltage Vsc to the supply start time point of the scan signal is, the scan signal is scanned more accurately.

Various methods for changing the duration of the period ranging from the supply start time point of the scan reference voltage Vsc to the supply start time point of the scan signal in the plasma display apparatus according to the first embodiment of the present invention may be applied to the plasma display apparatus according to the second embodiment of the present invention.

Further, the examples of numerical limitation on the first period and the second period in the first embodiment of the present invention may be applied to the second embodiment of the present invention.

A reason to reduce the duration of the period ranging from the supply start time point of the scan reference voltage Vsc to the supply start time point of the scan signal when the temperature of the plasma display panel is relatively high will be described with reference to FIG. 8.

FIG. 8 illustrates a reason to reduce the duration of a period ranging from a supply start time point of a scan reference voltage to a supply start time point of a scan signal when the temperature of the plasma display panel is relatively high.

Referring to FIG. 8, wall charges 800 and space charges 801 exist within discharge cells surrounded by a scan electrode Y, a sustain electrode Z and an address electrode X of the plasma display panel.

Since a predetermined driving voltage is supplied to the scan electrode Y, the sustain electrode Z or the address electrode X, the wall charges 800 may be produced by leading and then disposing the space charges 801 on the scan electrode Y, the sustain electrode Z or the address electrode X.

When the temperature of the plasma display panel increases, thermal energy is supplied to the wall charges 800 and the space charges 801 within the discharge cells such that the wall charges 800 and the space charges 801 actively move.

As a result, the wall charges 800 and the space charges 801 are recombined such that a neutralization rate of the wall charges 800 and the space charges 801 increases and the quantity of wall charges within the discharge cells decreases.

Accordingly, the quantity of wall charges within the discharge cells is excessively insufficient.

Therefore, when the temperature of the plasma display panel is relatively high, as illustrated in (b) of FIG. 7, the duration of the period ranging from the supply start time point of the scan reference voltage Vsc to the supply start time point of the scan signal relatively decreases. As a result, the sufficient quantity of wall charges remains within the discharge cell at the supply start time point of the scan signal, that is, at a generation time point of the address discharge such that an erroneous address discharge is prevented.

On the other hand, when the temperature of the plasma display panel is relatively low, the wall charges 800 and the space charges 801 slowly move. As a result, a neutralization rate of the wall charges 800 and the space charges 801 by the combination of the wall charges 800 and the space charges 801 decreases such that the quantity of wall charges 800 within the discharge cells relatively increases.

Accordingly, when the temperature of the plasma display panel is relatively low, as illustrated in (a) of FIG. 7, the duration of the period ranging from the supply start time point of the scan reference voltage Vsc to the supply start time point of the scan signal relatively increases. As a result, the quantity of wall charges sufficiently decreases at the supply start time point of the scan signal, that is, at a generation time point of the address discharge such that an erroneous address discharge is prevented.

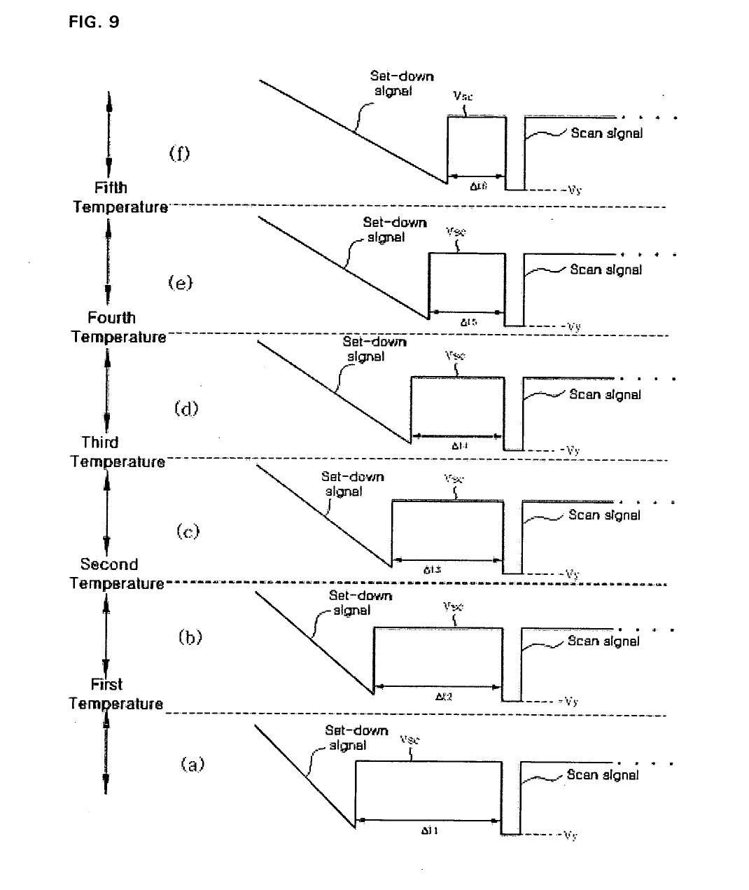

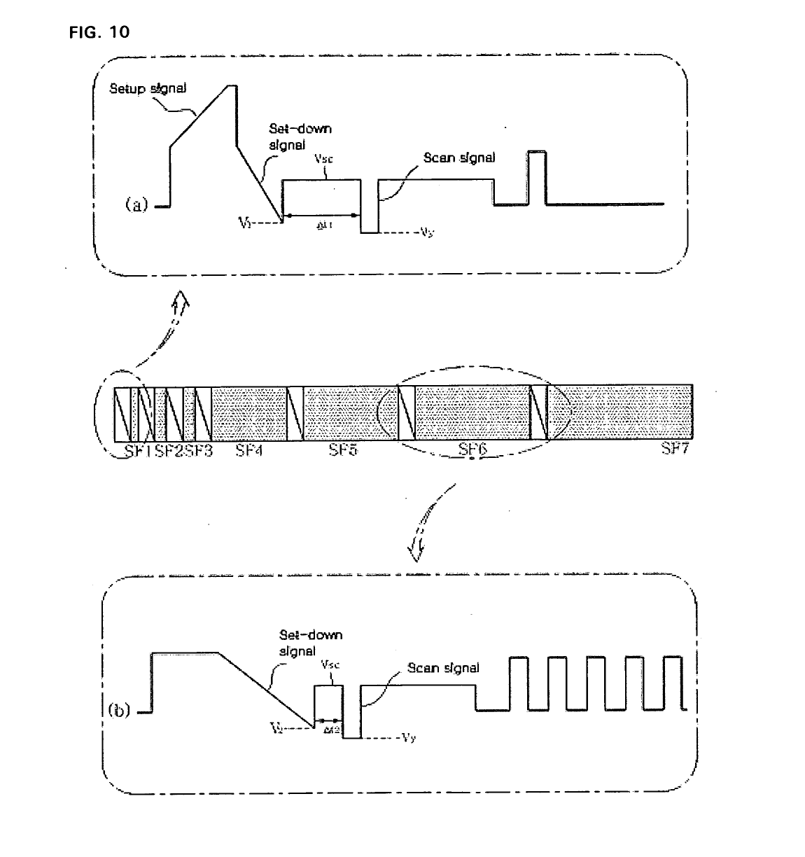

FIG. 9 illustrates a change in the duration of a period ranging from a supply start time point of a scan reference voltage to a supply start time point of a scan signal depending on the temperature of the plasma display panel.

Referring to FIG. 9, when a plurality of critical temperatures, for example, a first temperature, a second temperature, a third temperature, a fourth temperature, and a fifth temperature are set and the temperature of the plasma display panel comprises the critical temperatures, the duration of the period ranging from the supply start time point of the scan reference voltage to the supply start time point of the scan signal changes.

For example, as illustrated in (a) of FIG. 9, when the temperature of the plasma display panel is equal to or less than the first temperature, the period ranging from the supply start time point of the scan reference voltage Vsc to the supply start time point of the scan signal is set to Δt1.

As illustrated in (b) of FIG. 9, when the temperature of the plasma display panel is more than the first temperature and is equal to or less than the second temperature, the period ranging from the supply start time point of the scan reference voltage Vsc to the supply start time point of the scan signal is set to Δt2 with the duration less than the duration of the period Δt1.

As illustrated in (c) of FIG. 9, when the temperature of the plasma display panel is more than the second temperature and is equal to or less than the third temperature, the period ranging from the supply start time point of the scan reference voltage Vsc to the supply start time point of the scan signal is set to Δt3 with the duration less than the duration of the period Δt2.

In the same way as (a), (b) and (c) of FIG. 9, as illustrated in (d), (e) and (f) of FIG. 9, the period ranging from the supply start time point of the scan reference voltage Vsc to the supply start time point of the scan signal is set to Δt4, Δt5 and Δt6.

The changes in the duration of the period ranging from the supply start time point of the scan reference voltage Vsc to the supply start time point of the scan signal range from about 1 μs to about 50 μs during the period when the scan signal is first supplied to a scan electrode. At this time, the scan electrode is one of a plurality of scan electrodes.

As a result, the quantity of wall charges within the discharge cells is efficiently controlled and all of the driving period is also secured.

The changes in the duration of the period ranging from the supply start time point of the scan reference voltage Vsc to the supply start time point of the scan signal range from about 5 μs to about 15 μs during the period when the scan signal is first supplied to a scan electrode. At this time, the scan electrode is one of a plurality of scan electrodes.

FIG. 10 illustrates the duration of a period ranging from a supply start time point of a scan reference voltage to a supply start time point of a scan signal depending on a highest level voltage of a setup signal in a plasma display apparatus according to a third embodiment of the present invention.

A plasma display apparatus according to a third embodiment of the present invention a plasma display panel comprising a scan electrode, and a scan driver for supplying a driving signal to the scan electrode in a first subfield and a second subfield. The duration of a first period ranging from a supply start time point of a scan reference voltage to a supply start time point of a scan signal in the first subfield is different from the duration of a second period ranging from a supply start time point of a scan reference voltage to a supply start time point of a scan signal in the second subfield, depending on a highest level voltage of a setup signal.

Preferably, when the highest level voltage of the setup signal in the second subfield is less than the highest level voltage of the setup signal in the first subfield, the duration of the second period is less than the duration of the first period.

For example, when a frame comprises a plurality of subfields, a highest level voltage of a setup signal in a reset period of a first subfield is more than a highest level voltage of a setup signal in reset periods of the remaining subfields.

Referring to FIG. 10, the duration of a period ranging from a supply start time point of a scan reference voltage Vsc to a supply start time point of a scan signal in at least one subfield of a plurality of subfields of one frame is different from the duration of a period ranging from a supply start time point of a scan reference voltage Vsc to a supply start time point of a scan signal in another subfield.

For example, suppose that one frame comprises seven subfields SF1 to SF7 and the seven subfields SF1 to SF7 are arranged in ascending order of gray level weight.

As illustrated in (b) of FIG. 10, a second period ranging from a supply start time point of a scan reference voltage Vsc to a supply start time point of a scan signal in the sixth subfield SF6 is set to Δt2.

As illustrated in (a) of FIG. 10, a first period ranging from a supply start time point of a scan reference voltage Vsc to a supply start time point of a scan signal in the first subfield SF1, which is less than gray level weight of the sixth subfield SF6 and is more than a highest voltage of a setup signal in the sixth subfield SF6, is set to Δt1 with the duration more than the duration of the second period Δt2.

Various methods for changing the duration of the period ranging from the supply start time point of the scan reference voltage Vsc to the supply start time point of the scan signal in the plasma display apparatus according to the first and second embodiments of the present invention may be applied to the plasma display apparatus according to the third embodiment of the present invention.

Further, the examples of numerical limitation on the durations of the first period and the second period in the first embodiment of the present invention may be applied to the third embodiment of the present invention.

A reason to reduce the duration of the period ranging from the supply start time point of the scan reference voltage Vsc to the supply start time point of the scan signal in the subfield with relatively high gray level weight, for example, the sixth subfield will be described.

A setup signal with a relatively high voltage is used in the reset period of the subfield with relatively low gray level weight for the purpose of the generation of the stable discharge.

In other words, the initialization is completely performed by using the setup signal with the relatively high voltage in the subfield with relatively low gray level weight such that the whole discharge is stable.

Accordingly, the sufficient quantity of wall charges remain within the discharge cells in the reset period using the setup signal with the relatively high voltage.

On the other hand, since a large number of sustain signals are used in the subfield with relatively high gray level weight, the whole discharge is stable without using the setup signal with the relatively high voltage.

Accordingly, the setup signal may be omitted in the subfield with relatively high gray level weight.

Although, the setup signal with the relatively high voltage is omitted or is not illustrated in the attached drawings, the quantity of wall charges within the discharge cells is not sufficient in the reset period using the setup signal with the relatively low voltage.

As illustrated in (b) of FIG. 10, the duration of the period ranging from the supply start time point of the scan reference voltage Vsc to the supply start time point of the scan signal decreases in the, subfield with relatively high gray level weight. Accordingly, the wall charge sufficiently remain within the discharge cells at the supply start time point of the scan signal, that is, the generation start time point of the address discharge such that the erroneous address discharge is prevented.

The changes in the duration of the first period and the second period range from about 1 μs to about 50 μs during the period when the scan signal is first supplied to a scan electrode. At this time, the scan electrode is one of a plurality of scan electrodes.

The changes in the duration of the first period and the second period range from about 5 μs to about 15 μs during the period when the scan signal is first supplied to a scan electrode. At this time, the scan electrode is one of a plurality of scan electrodes.

The explanation was given of examples for changing the duration of the period ranging from the supply start time point of the scan reference voltage to the supply start time point of the scan signal using various methods such as a change in the temperature of the plasma display panel, a change in the highest voltage of the setup signal. However, the duration of a period ranging from a supply end time point of the set-down signal to a supply start time point of a scan signal may change.

More specifically, the plasma display apparatus comprises a plasma display panel comprising a scan electrode, and a scan driver for supplying a driving signal to the scan electrode in a first subfield and a second subfield. The duration of a first period ranging from a supply end time point of a set-down signal to a supply start time point of a scan signal in the first subfield is different from the duration of a second period ranging from a supply end time point of a set-down signal to a supply start time point of a scan signal in the second subfield.

When a temperature of the plasma display panel in the second subfield is more than a temperature of the plasma display panel in the first subfield, the duration of the second period is less than the duration of the first period.

The duration of the period ranging from the supply end time point of the set-down signal to the supply start time point of the scan signal can change using all of the example described in the first, second and third embodiments except the example illustrated in FIG. 6c. Further, the duration of the period ranging from the supply end time point of the set-down signal to the supply start time point of the scan signal can change the highest voltage of the setup signal.

All of the examples disclosed in the embodiments of the present invention may be used by combining the-examples.

The embodiment of the invention being thus described may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel comprising a scan electrode; and
a scan driver for supplying a driving signal to the scan electrode in a first subfield and a second subfield,
wherein the duration of a first period ranging from a supply start time point of a scan reference voltage to a supply start time point of a scan signal in the first subfield is different from the duration of a second period ranging from a supply start time point of a scan reference voltage to a supply start time point of a scan signal in the second subfield.

2. The plasma display apparatus of claim 1, wherein the changes in the duration of the first period and the second period range from about 1 μs to about 50 μs during the period when the scan signal is first supplied to a scan electrode, and
wherein the scan electrode is one of a plurality of scan electrodes.

3. The plasma display apparatus of claim 2, wherein the changes in the duration of the first period and the second period range from about 5 μs to about 15 μs during the period when the scan signal is first supplied to a scan electrode, and
wherein the scan electrode is one of a plurality of scan electrodes.

4. The plasma display apparatus of claim 1, wherein a difference between the duration of the first period and the duration of the second period ranges from about 1 μs to about 50 μs.

5. The plasma display apparatus of claim 4, wherein a difference between the duration of the first period and the duration of the second period ranges from about 10 μs to about 30 μs.

6. The plasma display apparatus of claim 5, wherein a difference between the duration of the first period and the duration of the second period ranges from about 15 μs to about 25 μs.

7. The plasma display apparatus of claim 1, wherein the duration of the first period and the duration of the second period are inversely proportional to the duration of a falling period of a set-down signal.

8. The plasma display apparatus of claim 1, wherein the duration of the first period and the duration of the second period are inversely proportional to a lowest level voltage of a set-down signal.

9. The plasma display apparatus of claim 1, wherein the duration of the first period and the duration of the second period are inversely proportional to the duration of a maintenance period of a voltage at a supply end time point of a set-down signal.

10. The plasma display apparatus of claim 1, wherein the duration of the first period and the duration of the second period are inversely proportional to the duration of a maintenance period of a voltage at a supply start time point of a set-down signal.

11. The plasma display apparatus of claim 1, wherein the duration of the first period and the duration of the second period are inversely proportional to the duration of a rising period of a setup signal.

12. The plasma display apparatus of claim 1, wherein the duration of the first period and the duration of the second period are inversely proportional to the duration of a maintenance period of a voltage at a supply end time point of a setup signal.

13. The plasma display apparatus of claim 1, wherein the duration of the first period and the duration of the second period are inversely proportional to the duration of a maintenance period of a voltage at a supply start time point of a setup signal.

14. A plasma display apparatus comprising:
a plasma display panel comprising a scan electrode; and
a scan driver for supplying a driving signal to the scan electrode in a first subfield and a second subfield,
wherein the duration of a first period ranging from a supply start time point of a scan reference voltage to a supply start time point of a scan signal in the first subfield at a first temperature is different from the duration of a second period ranging from a supply start time point of a scan reference voltage to a supply start time point of a scan signal in the second subfield at a second temperature.

15. The plasma display apparatus of claim 14, wherein when the second temperature is more than the first temperature, the duration of the second period is less than the duration of the first period.

16. The plasma display apparatus of claim 14, wherein the first temperature and the second temperature comprise either an internal temperature of the plasma display panel or an ambient temperature of the plasma display panel.

17. A plasma display apparatus comprising:
a plasma display panel comprising a scan electrode; and
a scan driver for supplying a driving signal to the scan electrode in a first subfield and a second subfield,
wherein the duration of a first period ranging from a supply start time point of a scan reference voltage to a supply start time point of a scan signal in the first subfield is different from the duration of a second period ranging from a supply start time point of a scan reference voltage to a supply start time point of a scan signal in the second subfield, and
wherein the duration of the first period and the duration of the second period depend on a highest level voltage of a setup signal.

18. The plasma display apparatus of claim 17, wherein when a highest level voltage of a setup signal in the second subfield is less than a highest level voltage of a setup signal in the first subfield, the duration of the second period is less than the duration of the first period.

19. A plasma display apparatus comprising:
a plasma display panel comprising a scan electrode; and
a scan driver for supplying a driving signal to the scan electrode in a first subfield and a second subfield,
wherein the duration of a first period ranging from a supply end time point of a set-down signal to a supply start time point of a scan signal in the first subfield is different from the duration of a second period ranging from a supply end time point of a set-down signal to a supply start time point of a scan signal in the second subfield.

20. The plasma display apparatus of claim 19, wherein when a temperature of the plasma display panel in the second subfield is more than a temperature of the plasma display panel in the first subfield, the duration of the second period is less than the duration of the first period.
